(19) United States
(12) Patent Application Publication
(10) Pub. No.: US 2024/0046241 A1
(43) Pub. Date: Feb. 8, 2024

(54) SYSTEMS AND METHODS FOR REVERSE CARD AUTHENTICATION WITH SINGLE-STEP VERIFICATION

(71) Applicant: Capital One Services, LLC, McLean, VA (US)

(72) Inventors: Xiaoguang ZHU, NewYork, NY (US); Samuel RAPOWITZ, Roswell, GA (US); Lin Ni Lisa CHENG, Fresh Meadows, NY (US)

(21) Appl. No.: 17/880,419

(22) Filed: Aug. 3, 2022

(51) Int. Cl. G06Q 20/32; G06Q 20/40; G06Q 50/12

(52) U.S. Cl. CPC G06Q 20/322; G06Q 20/405; G06Q 50/12

(57) ABSTRACT

Systems and methods for implementing a single step processing for two-step transactions involving an initial and a final amount. The proposed systems and methods incorporates a built-in logical operations and parameter acquisition scheme for identification of two-step transaction and internal computation of the final amount based on user specified logical operations and input parameters. Data values, corresponding to the input parameters, may be dynamically extracted from the transactions string and/or obtained from one or more applications running on the user device, and subsequently, processed with the specified logical operations to generate a final transaction amount from the initial transaction amount referenced in the transaction request. The final transaction amount may then be validated and a single authentication response transmitted to a payment gateway initiating the request.

### FIELD OF THE DISCLOSURE

The present disclosure relates to systems and methods for automated verification of electronic transactions, and more specifically to systems and methods for single-step verification of two-step verification transactions.

### BACKGROUND

Two-step transactions processing generally involves transactions associated with an estimated initial payment amount and a final payment amount to be validated at a later time by a user. The processing of such two-step transactions (e.g., transactions including a gratuity/tip payment component) generally involve an initial exchange of transaction messages for authentication of the payment source corresponding to the initial transaction amount, and a second exchange of transaction messages for a final amount (e.g., when a user adds a gratuity amount to the initial transaction amount, and validates the final amount with a signature.)

The aforementioned two-step approach for processing transactions, is not only cumbersome for users and service providers by requiring a second step, but also involves a significant time delay between an initial transaction request, and a final validation response. In addition, the two-step transaction processing scheme imposes a heavier load on network systems and/or traffic, by requiring two separate request and/or response messages to be communicated between a merchant payment gateway and a remote transaction validating server and/or entity. These and other shortcoming exist in existing platforms for electronic processing of two-step transactions.

### SUMMARY OF THE DISCLOSURE

One aspect of the present disclosure is directed to a system and process for streamlining two-step processing of transactions involving an estimated (initial) and a final transaction amount, by generating a single validation response for the final transaction amount. The final transaction amount being automatically computed based on a set of user-specified logical operations and input parameters that may be coded into a finanacial account profile associated with a primary user account and/or connected to a user payment card.

Accordingly, embodiments of the present disclosure are directed to a method for optimizing two-step electronic processing of transactions involving an estimated transaction amount, the method comprising: identifying, based on transaction string data, a transaction message encoding a merchant identifier associated with a first merchant category, the transaction message corresponding to a request for a first transaction amount; processing, by a transaction processing server, the first transaction amount with one or more logical operations to compute a second transaction amount, wherein the one or more logical operations are derived from one or more user-specified tipping parameters associated with the merchant identifier; and transmitting, in response to the transaction request message for the first transaction amount, a transaction authorization message for the second amount, to a payment gateway associated with the transaction request for the first transaction amount.

The computation of the second transaction amount may comprises: calculating a gratuity amount based on, the merchant identifier, the first transaction amount and the one or more user-specified tipping parameters associated with the merchant identifier, and increasing the first transaction amount by the gratuity amount calculated. In some examples, the calculation of a gratuity amount and subsequent generation of the final payment amount may be conducted by application of one or more logical operations selected from a set of logical operations associated a user payment account, wherein the selected logical parameters are predetermined for a particular identified merchant in accordance to instructions provided in a user financial account associated with the payment card. The instructions may then be retrieved and utilized to modify the transaction processing routine for the computation of the gratuity amount and generation of a single authentication response for the final payment amount.

In some embodiments the set of logical operations may be accessible to the transaction processing routine a process (e.g., for the purpose of computing the second, and possibly the final, transaction amount) via one or more Application Programming Interface (API) calls. The one or more logical operations may be specified in accordance to one or more user-specified tipping parameters that may be inputted electronically via a modified user interface, the modified user interface being implemented as one or more of a payment application interface stored on a user mobile device or a web interface associated with a user payment account. Upon completing the computation of the final transaction amount based on provided parameters, a notification message may be transmitted to the user via the modified user interface, prompting the user to confirm the second transaction amount, prior to generating the transaction authorization message approving the second transaction amount.

In accordance to some embodiments, the first merchant category may correspond to a user-provided listing of merchant identifiers associated with one or more user-specified tipping parameters. The set of parameters provided via the modified user interface, may further comprise a variable for specifying a length of stay, for a user, at a service location of a merchant matching the first merchant category, the length of stay being determined based on real-time navigation and location data retrieved from one or more navigation-related applications running on a mobile device of the user. The final transaction amount may then be increased in proportion to the length of stay at the service location of the merchant in accordance to logical instructions and data parameters inputted and/or approved by the user.

Another aspect of the present disclosure is directed to a system for electronic processing of two-step transactions, the system comprising: a computer hardware arrangement configure to: identify, based on transaction string data, a transaction message encoding a merchant identifier associated with a first merchant category (e.g., corresponding to a user-provided listing of merchant identifiers associated with one or more user-specified tipping parameters and input data variables), the corresponding transaction message being associated with a request for a first transaction amount. The system may be further configured to process the first transaction amount with one or more logical operations to compute a second transaction amount, wherein the one or more logical operations are derived from one or more user-specified tipping parameters associated with the merchant identifier. The system may be further configured to transmit, in response to the transaction message for the first transaction amount, the transaction authorization message for the second amount, to a payment gateway associated with the transaction request for the first transaction amount.

The system and/or computer hardware arrangement may be configured to compute the second transaction amount by calculating a gratuity amount based on, the merchant identifier, the first transaction amount and the one or more user-specified tipping parameters associated with the merchant identifier, and increase the first transaction amount by the gratuity amount calculated. In some examples, the one or more logical operations, derived from one or more user-specified tipping parameters maybe selected from a set of user-specified tipping parameters and input data variables associated a user payment account. The computer hardware arrangement may be configured to access the set of logical operations to compute the second transaction amount, via one or more Application Programming Interface (API) calls.

The system may further comprise a modified user interface to capture one or more user-specified tipping parameters and input data variables, the modified user interface being implemented as one or more of a payment application interface stored on a user mobile device or a web interface associated with a user payment account. In some embodiments, the computer hardware arrangement may be further configured to transmit a notification message, via the modified user interface, to prompt for a user confirmation of the second transaction amount.

In some embodiments, the system may be further configured to determine a length of stay, for a user, at a service location of a merchant matching the first merchant category, the length of stay being determined based on real-time navigation and location data retrieved from one or more navigation-related applications running on a mobile device of the user. The computed gratuity amount and the subsequent second and/or final transaction amount may then be automatically increased in proportion to the length of stay at the service location of the merchant.

One aspect of the present disclosure is directed to a non-transitory computer-accessible medium comprising instructions for execution by a computer hardware arrangement, wherein, upon execution of the instructions the computer hardware arrange is configured to perform procedures comprising: identifying, based on transaction string data, a transaction message encoding a merchant identifier associated with a first merchant category, the transaction message corresponding to a request for a first transaction amount; processing, by a transaction processing server, the first transaction amount with one or more logical operations to compute a second transaction amount, wherein the one or more logical operations are derived from one or more user-specified tipping parameters associated with the merchant identifier, and transmitting, in response to the transaction request message for the first transaction amount, a transaction authorization message for the second amount, to a payment gateway associated with the transaction request for the first transaction amount. In some embodiments, the computation of the second transaction amount may comprises: calculating a gratuity amount based on, the merchant identifier, the first transaction amount and the one or more user-specified tipping parameters associated with the merchant identifier, and increasing the first transaction amount by the gratuity amount calculated.

### BRIEF DESCRIPTION OF THE DRAWINGS

Various embodiments of the present disclosure, together with further objects and advantages, may best be understood by reference to the following description taken in conjunction with the accompanying drawings.

FIG. 1 is an exemplary implementation of exiting schemes for electronic processing of two-step transaction involving two separate network request and/or response messages for completing the transaction processing.

FIG. 2 is an exemplary operational block diagram demonstrating a general operational flow involved in electronic processing of two-step transaction with a single request and response message, in accordance to some embodiments of the present disclosure.

FIG. 3 is an exemplary block diagram illustrating the construction of a merchant-specific set of logical operations with dynamically and statically acquired input parameter values for modifying initial transaction amount, in accordance to some embodiments of the present disclosure.

FIG. 4 is block diagram illustrating a process related to extraction of a merchant identifier from a transaction string and acquisition of data values corresponding to input parameters of a merchant-specific logical expression specified by a user, in accordance to some embodiments of the present disclosure.

FIG. 5 is a flow diagram of an exemplary automated single step processing scheme based on user-specified logical operations and data parameters, in accordance to some embodiments of the present disclosure.

FIG. 6 is an illustration of an exemplary implementation of single-step transaction processing system based on built-in tip-computation logic, featuring an added layer of security involving using a contactless card for authentication, in accordance to some embodiments of the present disclosure.

FIG. 7 is a block diagram illustration of an embodiments involving a portable payment gateway device and a user mobile device for direct initiation of a transaction request with a final amount, authenticated via a contactless card, in accordance to some embodiment of the present disclosure.

FIG. 8 is an illustration of an exemplary block diagram of an exemplary system, in accordance to some embodiments of the present disclosure.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

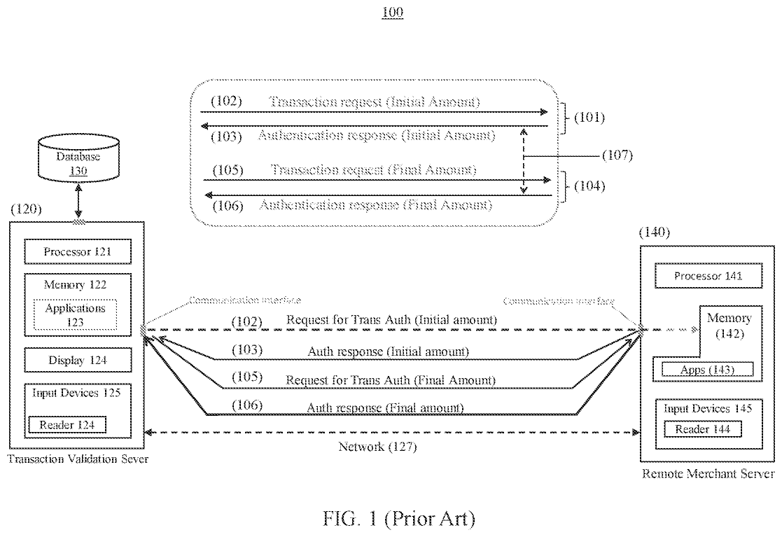

FIG. 1 illustrates some key drawbacks of the existing schemes for two-step transaction processing which generally comprises two separate communication sessions consisting, for example, of a communication session 101, associated with transaction request-response transmissions 102 and 103 for an initial transaction amount, and a communication session 104, associated with transaction request-response transmissions 105 and 106 referencing a final transaction amount.

As such, conventional processing schemes, for two-step transactions, suffer from two main deficiencies. One drawback of the exiting implementation involves the amount of network traffic generated by requiring two separate communication streams and/or sessions, such as communication sessions 101 and 104. The latter involves a fist set of request and response transmissions (e.g., 102, 103) for an initial transaction amount, and the former involves a second set of request and response transmissions (e.g., 105, 106) for a final transaction amount. Moreover, the issuance of a final transaction validation response (106) generally involves a time delay (107) as the communication session 104 is established at a later time following the completion of information exchange across communication session 101.

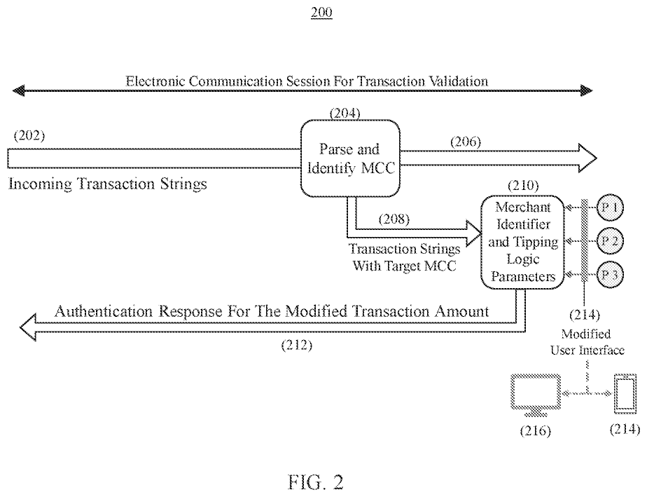

FIG. 2 illustrates an exemplary operational overview (200) for single-step transaction processing, in accordance to an embodiment of the proposed solution. The single-step transaction processing scheme (200) comprises near-instant validation of a two-step transaction request, across a single communication session (e.g., session 201) established between a transaction initiating entity and a transaction validating entity. The exemplary embodiment of the single-step transaction processing scheme (200) may include operations such as parsing a set of incoming transaction request strings (202) for identifying a Merchant Category Code (MCC) encoded therein as represented, for example, by the operational block (204). Identified transaction strings associated with a target MCC and/or a target merchant identifier (extracted from the incoming transaction strings) maybe redirected, as shown by the transaction data path (208) to a built-in logic processing module (210) for computation of a final transaction amount associated with the transaction request. Transactions not identified with a target condition may be directly sent to a validation process (as represented by transaction stream 206.)

Referring back to FIG. 2, module 210 may take in a set of input parameters (e.g., P1, P2 and P3) as defined by a user, via a modified user interface (213). The modified user interface (213) may be further configured to communicate one or more data values statically inputted by a user and/or dynamically acquired from one or more internal and/or external sources. The one or more data values may be associated with one or more corresponding input parameters specified in a tip-computation logical expression. The one or more input parameters may further comprise a set of logical operators for expressing a merchant-specific tip-computation logical expression as a function of one or more input parameters provided by the user. The one or more input parameter values may also correspond to information retrieved from the incoming transaction string and/or one or more applications running on a user mobile device (e.g., user computing and/or mobile device 214) and/or a corresponding application server. A final transaction amount may then be computed by module 210, based on pre-processing an initial transaction amount (extracted from the transaction string) with a corresponding merchant-specific tip-computation logical expression. Upon computation of a final transaction amount, a transaction validation response (212) for the final transaction amount may be transmitted back to a transaction initiating entity (e.g., merchant server). As discussed above, the aforementioned information exchange may take place across a single communication session 201, that may be established across a public network.

The modified user interface (213) may be implemented as part of one or more (modified) mobile applicatin stored on a user mobile device (214), and/or a web interface (216) of a user online account. As described above, the modified user interface (213) serves as an interface for a user to express a tip-computing formula as a function of one or more input parameters. The input parameters may be associated with one or more static coefficients and/or variable data, that may be internally and/or externally collected (e.g., data values corresponding to one or more electronically recorded and tracked user activities).

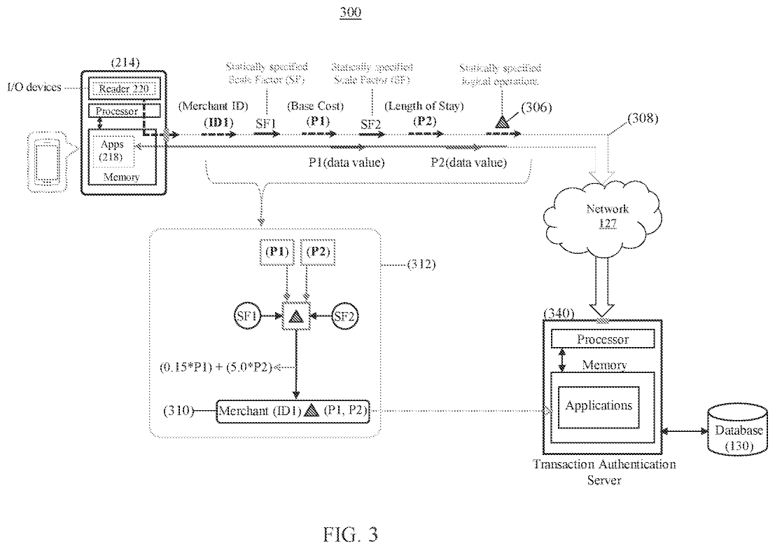

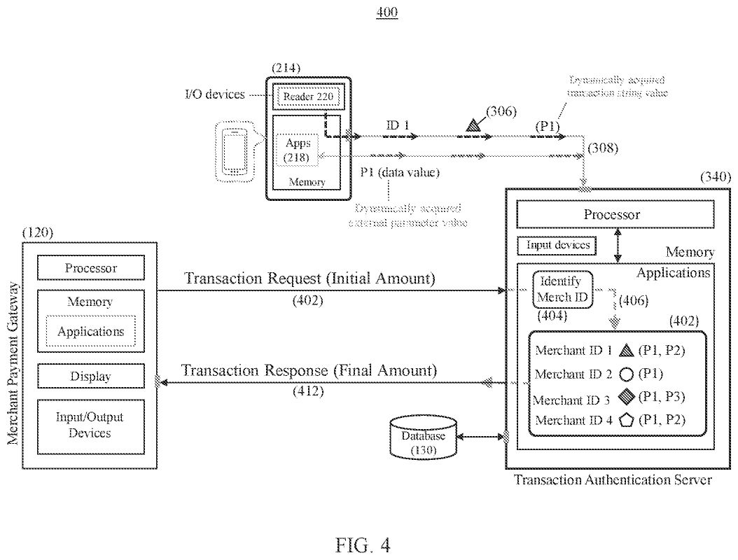

Some non-limiting examples of internally collected data may include data from applications running on user mobile device such as a Global Positioning System (GPS) based navigation application, and browser plugins that may be installed on a browser application, stored on user device, for tracking user's browsing patterns. Non-limiting examples of externally collected data may include transactional information provided by or retrieved from one or more financial account servers linked to one or more financial instruments associated with the user. The construction and operation of merchant-specific logical expression for automated computation of a final transaction amount is further illustrated and described with reference to FIGS. 3 and 4.

FIG. 3 illustrates an exemplary system implementation (300) for facilitating the construction of a merchant-specific logical expressions (e.g., 310) as a function of a set of user-specified parameters (e.g., P1, P2). The set of user-specified parameters may be inputted through the modified user interface (213), implemented, in accordance to example 300, via a mobile application stored on the user mobile and/or computing device (214). Accordingly, FIG. 3 is directed to an exemplary system (300) for implementing built-in tip computation logic to streamline the processing of two-step transactions—In this regards, the exemplary embodiment (300) illustrate the construction of a merchant-specific logical expression (e.g., logical expression 310 specific to merchant ID1) as a function of one or more user-specified parameters (e.g., ID1, P1, P2). Execution of the logical expression (310) may first require the acquisition of corresponding data values associated with the input parameters specified in the merchant-specific logical expression.

With reference to FIG. 3, a user may provide, via the modified interface (213) implemented on the mobile device (214), one or more inputs corresponding to a set of parameters and/or parameter coefficients to construct the exemplary merchant-specific logical expression (310). For example, the user-provided parameter ID may correspond to a merchant identification information (e.g., merchant name) for identifying, from a set of candidate transactions, one or more (two-step) transactions matching the specific merchant identifier (e.g., ID1)—and identifying a corresponding logical expression for pre-processing of the one or more two-step transactions matching the merchant identifier ID1. By way of an example and with reference to FIG. 2, the set of candidate transactions may correspond to the transaction stream (208), filtered from the plurality of incoming transaction requests (202), by the processing block (204), and redirected to the processing module (210) for alternate processing with the built-in tip-computation logic.

Referring back to FIG. 3, user-provided parameter (P1) may correspond to a variable for representing the base cost or the initial transaction amount. The value associated with parameter (P1) (e.g., P1(data value) corresponding to the initial transaction amount) may be extracted from an identified two-step transaction string at the transaction processing time (for example, by the parsing and matching operations performed by module and/or process 204 that may be running as part of application 218 stored on the user mobile device (214)). A user may provide additional parameters based on a particular merchant. For example, in the exemplary embodiment 300, the user provides a second parameter (P2) to represent the length of time spent at the service location corresponding to merchant ID1. The value associated with parameter P2 (e.g., P2 (data value)) may be retrieved from one or more applications stored on the user mobile device (214) and/or a corresponding application server. For example navigation and location data from a GPS application running on the user device (214) may be used to determine a length of stay at a service location corresponding to merchant identifier (ID1). In accordance to some embodiments, GPS application data may also be used to validate an incoming transaction request, by matching a user specified merchant identifier (ID1), with the GPS location data to verify that a user location corresponds to a known merchant service location for merchant ID1.

A user may also provide a set of logical operators for connecting the inputted parameters into a logical expression. For example, parameter 306, denoted by a triangle symbol, corresponds to set of logical operators used to connect parameters (P1) and (P2), in association with merchant ID1, into the merchant-specific logical expression (310), as illustrated by the embedded block diagram (312). The merchant-specific logical expression (310) provided as a function of the base cost or initial transaction amount (P1) and the length stay (P2) may then be stored, for example, as a distinct data object on the transaction authentication server (340) and/or a database (130) communicatively coupled to the server (340).

With reference to exemplary implementation 300 illustrated in FIG. 3, a user may also input one or more constant coefficients or scale factors (e.g., SF1 and SF 2) to variably weigh one or more parameter value in determining an outcome of a merchant-specific logical expression. For example, the exemplary merchant-specific logical expression (310), for modifying a transaction amount in an incoming transaction request associated with the merchant identifier (ID1), involves adding 15% of the base cost (0.15*P1), as specified by SF1, to 5 times the length of stay (5*P2), as specified by SF2, with the length of stay specified, for example, in hours. Therefore, with reference to FIG. 3, the logical expression 310 increases the tip amount, calculated as 15% of the base cost (e.g., 0.15*P1), in proportion to the length of stay at the service location of the merchant (e.g., by $5.00 for each hour spent at the merchant (ID1) service location.)

By inputting various arrangement of logical operators and values of constants coefficients and scaling factors (SF) a user may modify the operations of the tip-computation process. For example, if the user intend to increases the tip amount, calculated as 15% of the base cost (e.g., 0.15*P1), by $5.00 for each additional hour (after the first hour) spent at the merchant (ID1) service location, the merchant-specific logical operation may be specified as (0.15*P1)+(5*(P2−1)). The user-inputted parameters and scaling factors, as well as parameter values extracted from a transaction string and/or retrieved from one or more applications tracking user activity, may be communicated from the user mobile and/or computing device (214) to the transaction authentication server (340), across a network data path (308). The network data path (308) may extend across public network 127 and further direct notifications and user prompt messages from the transaction authentication server (340) back to the user mobile and/or computing device (214).

The incorporation of the proposed solution for generating built-in customized tip-calculating functionality into the transaction processing flow can streamline the transaction process on both the merchant and the user end (e.g., facilitating two-step transaction processing instantly via a single communication session, as illustrated in FIG. 2, and further in FIGS. 4, 6 and 7), while optimizing network communications and traffic associated with such two-step transaction processing platforms as will be further described with reference to FIG. 4.

With regards to the aforementioned optimization of network communication and/or traffic load, FIG. 4 illustrates an exemplary system implementation (400) involving application of custom logical expressions (e.g., constructed as shown in FIG. 3) to an identified two-step transaction request (e.g., first network transmission 402) to generate, almost instantaneously (e.g., without delay 107 illustrated in FIG. 1) a single validation response referencing a final transaction amount (second network transmission 412)—thus improving both the length of time and the network load associated with such transaction processing operations.

Embodiment 400 illustrates an implementation of a modified scheme for processing two-step transactions using a built-in logical computation module and/or process, such as module 210, that may operate by, for example, using the dataset (403) comprising records of merchant-specific logical tip-computation expressions, such as logical expression/formula 310. Merchant-specific records including the corresponding tip-computation expressions may be stored as distinct data objects within the dataset (403).

In the exemplary embodiment (400) merchant-specific logical expressions, stored in the dataset (403), may correspond to various combination of logical operators, represented as various geometric shapes expressed as a function of set of input parameters (e.g., P1, P2, etc.) and matched with a specific merchant identifier (e.g., ID1, ID2, etc.). The input parameters specified with various logical expressions may be associated with statically inputted and/or dynamically acquired data values.

Referring back to the operation associated with the exemplary system 400, a transaction request message (402), associated with an initial transaction amount, may be received by the transaction authentication server (340), storing the dataset (403). A process running on transaction authentication server 340 (e.g., process 404) may be configured to parse and inspect incoming transaction strings (such as transaction request message 402), to identify transactions associated with a target attribute, and redirect the identified transaction (406) to be matched with a corresponding merchant-specific logical tip-computation expression stored in dataset 403. The target attribute may correspond to an MCC and/or a merchant identifier matching one or more merchant categories and/or service locations associated, for example, with tip-based transactions. The one or more merchant categories and/or service locations may also be specified by the user, an automated process (e.g., process 204 illustrated in FIG. 2), and/or a combination of user inputs and operations associated with the automated process (e.g., process 204).

As described above, identification of a two-step transaction may comprise matching a merchant identifier, extracted from a transaction string, to a merchant ID associated with one or more tip-computation logical expressions stored, for example, in the dataset (403). In some embodiments, a process of identifying a target attribute, representative of a two-step transaction, may be applied to a set of transactions (filtered from a plurality of incoming transaction requests (202)) identified as corresponding to one of one or more candidate MCCs (e.g., as represented by transaction data path 208 in FIG. 2.)

Upon identification of a corresponding tip-computation logical expression, one or more API calls, for retrieving one or more data values corresponding to the input parameters of the identified merchant-specific expression, may be issued. The one or more input data values may comprise data extracted from a transactions string (e.g., initial transaction amount), data acquired via a prompted user input at run time, data associated with operation of one or more applications running on the user mobile and/or computing device (110), and/or a corresponding application server, as well as any data pre-specified as relevant to the calculation of a final transaction amount using an identified merchant-specific logical expression. A final transaction amount may be computed by executing the corresponding merchant-specific logical expression and a transaction validation response (412) for the computed final transaction amount may be transmitted to the transaction-initiating merchant server (120). In accordance to some embodiments, a user confirmation input, prompted at run time, may be required for validating a computed final transaction amount.

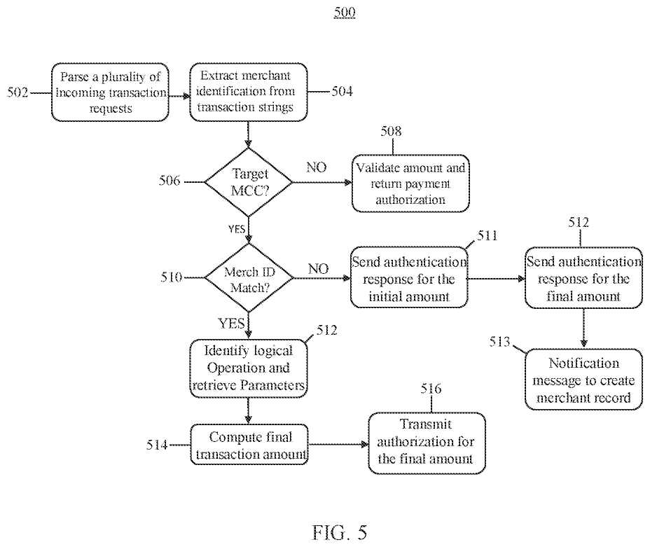

FIG. 5 illustrates a exemplary flow diagram (500) for an automated single-step processing scheme of two-step transactions based on a user-customized built-in tip-computation process. With reference to the exemplary process flow (500), steps 502 and 504 correspond to collection, parsing and filtering of incoming transaction strings to identify (e.g., based on extraction of a merchant category code (MCC) and/or any other merchant identifying information from the parsed transaction strings) transaction requests associated with two-step processing. In accordance to one embodiment, identification of a two-step transaction may be based on matching an MCC extracted from a transaction string with a listing of target MCCs to identify a match as shown at step 506. If no match is identified, the transaction is processed and a validation or denial response corresponding to the specified transaction amount is returned (step 508). If a transaction request matching a target MCC is identified at step 506, a merchant identifier is extracted or derived from the corresponding transaction string and compared (step 510) with a listing of merchant identifiers associated with a logical tip-computation expression. If no match is identified at step 510, the transaction is processed based on a two-step validation scheme involving a transmission of an authentication response associated with an initial transaction amount (step 511), and, at a later time, upon receiving a transaction request with a user-validated final transaction amount (e.g., including a gratuity amount added to the initial transaction amount with a valid user signature) sending an authentication response for the final transaction amount back to the transaction-initiating merchant (step 512).

According to some embodiments, at step (513) a notification message may be generated and displayed, on the user mobile device, as a user-prompt to create a merchant-specific tip-computation logical expression for the transaction-initiating merchant associated with steps 511 and 512.

If a match, between the extracted merchant identifier and a stored listing of merchant identifiers associated with a logical tip-computation expression is, identified at step (510), the corresponding tip-computation logical expression along with the corresponding input parameter values (identified and retrieved from various sources at step 514) may be used to compute a final transaction amount and/or a gratuity amount (to be added to the initial transaction amount) at step 515, and a transaction validation response for the computed final transaction amount may be transmitted back to the requesting payment gateway (e.g., the transaction-initiating merchant), at step 516.

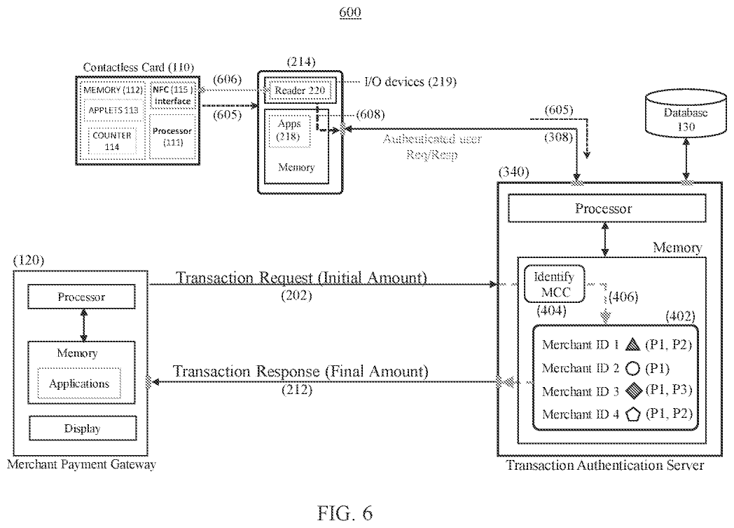

FIG. 6 illustrates an embodiment of the proposed system/method, for streamlined processing of two-step transactions, supplemented with a contactless card (110). Contactless card 110 may be used in a specific configuration with other components of the system, as shown in FIG. 6, to provide an additional layer of security in the operation of the proposed system and method. The contactless card may comprise an integrated processor (111) and memory (112). The integrated memory (112) may store one or more applets (113) that may be communicatively coupled to one or more applications (e.g. application 218) running on the user mobile and/or computing device (214) and/or one or more applications stored on a corresponding application server. The card-integrated memory (112) may also store an application transaction counter (114) to keep track of a proper sequence of operations associated with a transaction conducted using the contactless card. The contactless card (110) may further comprise a Near Field Communication (NFC) interface (115) to facilitate NFC communication with a reader (e.g., reader 220). Encrypted authentication data (605), securely stored on the contactless card (110) and read via the reader (220), may then be transmitted to the transaction authentication server (340) to authenticate a user confirmation response with respect to a computed final transaction amount.

In the exemplary embodiment 600 a plurality of incoming transaction requests (202) from one or more remote sources (collectively represented as merchant payment gateway (120) in the example 600) are parsed and processed to identify one or more two-step transaction requests (406) which are then redirected for processing with a corresponding merchant-specific logical expression (e.g., stored as a data object in dataset 403) to compute a final transaction amount. Based on the computed final transaction amount, a single validation response, for each of the identified two-step transaction requests, may be transmitted back to each corresponding merchant server (e.g., merchants initiating an initial transaction requests for a two-step transaction), as illustrated by the transaction response (212) in the example 600. In some embodiments, generation of a validation response for a computed final transaction amount may be subject to a confirmation signal from a user. In the exemplary embodiment 600 a user confirmation signal associated with a two-factor strong authentication, may be provided via encrypted authentications information (605) securely stored on the contactless card (110) and read, by the user computing and/or mobile device (214), via the NFC link 606. In this regard, a user, upon being prompted on the mobile device (214) for an authentication input, may bring the contactless card within the NFC range of the mobile device reader (220) to initiate the NFC transmission of encrypted authentication data (605). The encrypted user authentication data (605) may then be transmitted to the transaction authentication server (340) for validation, as shown by the exemplary illustration in FIG. 6. The authentication signal (e.g., associated with the encrypted authentication data 605) may then serve as a two-factor strong user authentication based on confirming a presence of both the user mobile device (214) and the contactless card (110) associated with the user.

In some embodiments, communications between transaction authentication server (340) and user mobile device 214 (e.g., corresponding to exchange of notification and/or user-prompt request message and confirmation and/or authentication response messages between the authentication server and the mobile device) may occur across the network data session (308) that may also be used, for example, for communication of user-inputted information (608), encrypted user authentication data (605) and system-provided input parameter data values associated with the implementation and execution of merchant-specific logical tip-computation expressions.

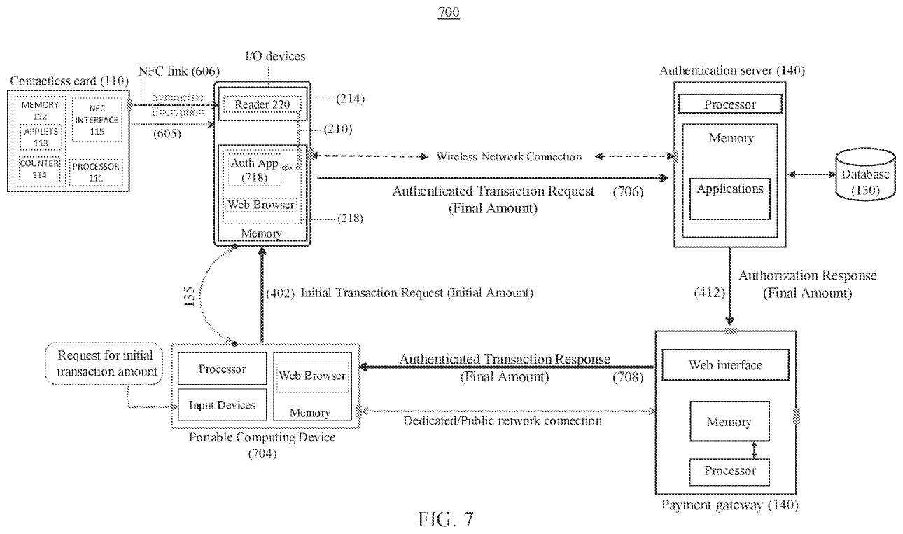

FIG. 7 illustrates an exemplary embodiment involving a scheme whereby an initial transaction request (702) may be directly transmitted to a user mobile device (214), running a corresponding application (e.g., authentication application 718), by a portable merchant computing device (704) (e.g., a portable Point of Sale (POS) device operated by a service personal and brought in transmission proximity of the user mobile device). This is illustrate in the exemplary embodiment (700) by transmission path 135 between the merchant POS computing device (704) and the user mobile device (214) running a corresponding application (718). The initial transaction request, comprising transaction-related data such as an initial payment amount, may then be displayed to the user on an interface of the corresponding application rendered on the user device (214). The communication may take place over a direct short range communication channel (135) using a Bluetooth Low Energy (BLE) link, a Wi-Fi link and/or any other short range communication protocol that may be established between the portable (merchant) computing device (704) and the user mobile device (214). The user may then select the appropriate merchant-specific logical expression to compute a final transaction amount and/or the gratuity amount to be added to the initial transaction amount, which may then be displayed to the user on an interface of the user mobile device (214). In some embodiments, the user may also forgo the application of a pre-set logical expression for the calculation of a final transaction amount and directly specify, on the application interface, an amount for the gratuity and/or the final transaction amount to be transmitted to an authentication server for validation. However, since the computation of the final amount, in the described embodiment, may not be conducted on the back-end based on pre-defined logical expression records securely stored on the server, the validation step may require a strong authentication signal from the user prior to being accepted. The NFC transmittable user authentication data (605), stored on the contactless card (110) and read by reader 220 of the user mobile device (214), may be used to provide such a strong authentication signal for authenticating a user payment request and generating a single validation response for the modified amount directly entered by the user.

As such, in accordance to some embodiments of the present disclosure, the initial transaction request (702) may be directly transmitted, from a portable POS device (704) communicatively coupled with merchant payment gateway (140), to a user computing and/or mobile device (214), via short range communication (135), to be processed by an application (718) running on the user device. Upon receiving the initial transaction request (702), referencing an initial transaction amount, the user may directly input, onto an application interface rendered on the mobile device display, a final transaction amount and/or a gratuity amount to be added to the initial transaction amount. A transaction validation request message (706) comprising the final user-inputted transaction amount, and the one or more user authentication inputs, may then be transmitted to the authentication server (140) for processing. The one or more user authentication inputs may correspond to one or more user identification data records, securely stored on the contactless card (110), and read via an encrypted NFC transmission (605) from the contactless card. Upon verifying the encrypted user authentication information, the transaction authentication server may transmits a transaction validation response (708) for the final transaction amount, to the merchant payment gateway (140).

In some cases, a two-step transaction request may be received from a new merchant location (e.g., no existing pre-tip logic entry associated with the merchant identifier extracted from the transaction string). In such cases, some embodiments of the proposed system and process may generate prompted gratuity amount suggestions to the user based on an analysis of pre-defined and/or real-time inputted tip amounts associated with a plurality of other system users. Based on an analysis of this data, an average, minimum and/or maximum tip amount for a particular merchant may be provided to the user—Based on the provided information, the user may enter a different tip amount directly onto the application interface, and/or create or updated a merchant-specific logical expression (e.g., average tip amount, and/or average tip amount scaled by the length of stay and the initial transaction amount.)

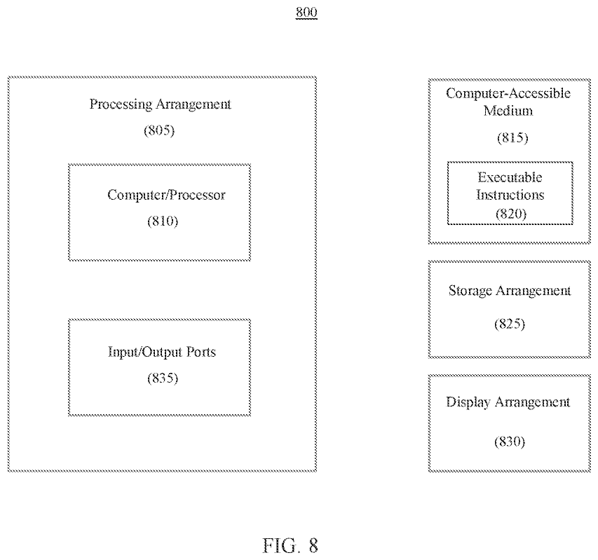

FIG. 8 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 805. Such processing and/or computing arrangement 805 can be, for example entirely or a part of, or include, but not limited to, a computer and/or processor 810 that can include, for example one or more microprocessors, and use instructions stored on a computer-accessible medium (e.g., RAM, ROM, hard drive, or other storage device).

As shown in FIG. 8, for example a computer-accessible medium 815 (e.g., as described herein above, a storage device such as a hard disk, floppy disk, memory stick, CD-ROM, RAM, ROM, etc., or a collection thereof) can be provided (e.g., in communication with the processing arrangement 805). The computer-accessible medium 815 can contain executable instructions 820 thereon. In addition or alternatively, a storage arrangement 825 can be provided separately from the computer-accessible medium 815, which can provide the instructions to the processing arrangement 805 so as to configure the processing arrangement to execute certain exemplary procedures, processes, and methods, as described herein above, for example.

Further, the exemplary processing arrangement 805 can be provided with or include an input and/or output ports 835, which can include, for example a wired network, a wireless network, the internet, an intranet, a data collection probe, a sensor, etc. As shown in FIG. 8, the exemplary processing arrangement 805 can be in communication with an exemplary display arrangement 830, which, according to certain exemplary embodiments of the present disclosure, can be a touch-screen configured for inputting information to the processing arrangement in addition to outputting information from the processing arrangement, for example. Further, the exemplary display arrangement 830 and/or a storage arrangement 825 can be used to display and/or store data in a user-accessible format and/or user-readable format.

According to some embodiments, one or more data analytics and machine learning routines may be applied to supplement the computation of the processed user information as described above. This may be supplemented by a use of various prediction models such as ones that can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-accessible medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously collected data from a plurality of system users. Previously collected user data may correspond to a user transactional activity analyzed in conjunction, for example, with navigation data from a user mobile device. In other examples, the training datasets may comprise continuously-collected data based on the current operation of the instant system and continuously-collected data from the operation of other systems (e.g., real-time tracking of electronic transaction data and the data from a user's GPS application.) In some examples, the training dataset may include anticipated data, such as the anticipated future travel pattern and purchasing action pattern, currently scheduled workloads, and planned future workloads, for the instant system and/or other systems. In other examples, the training datasets can include previous predictions for the instant system and other types of system and may further include results data indicative of the accuracy of the previous predictions. In accordance with these examples, the predictive models described herein may be training prior to use and the training may continue with updated data sets that reflect additional information.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for optimizing two-step electronic processing of transactions involving an initial and a final transaction amount, the method comprising:
identifying, based on transaction string data, a transaction message encoding a merchant identifier associated with a first merchant category, the transaction message corresponding to a request for a first transaction amount;
processing, by a transaction processing server, the first transaction amount with one or more logical operations to compute a second transaction amount, wherein the one or more logical operations are derived from one or more user-specified tipping parameters associated with the merchant identifier; and
transmitting, in response to the transaction request message for the first transaction amount, a transaction validation response for the second amount, to a payment gateway associated with the transaction request for the first transaction amount.

2. The method of claim 1, wherein a computation of the second transaction amount comprises: calculating a gratuity amount based on, the merchant identifier, the first transaction amount and the one or more user-specified tipping parameters associated with the merchant identifier, and increasing the first transaction amount by the gratuity amount calculated.

3. The method of claim 1, wherein the one or more logical operations are selected from a set of logical operations associated a user payment account.

4. The method of claim 3, wherein the set of logical operations is accessible, by a process associated with the computation of the second transaction amount, via one or more Application Programming Interface (API) calls.

5. The method of claim 1, wherein the one or more user-specified tipping parameters are inputted electronically via a modified user interface, the modified user interface being implemented as one or more of a payment application interface stored on a user mobile device or a web interface associated with a user payment account.

6. The method of claim 5, further comprising transmitting a notification message, via the modified user interface, prompting for a user confirmation of the second transaction amount, prior to generating the transaction validation response for the second transaction amount.

7. The method of claim 1, wherein the first merchant category correspond to a user-provided listing of merchant identifiers associated with one or more user-specified tipping parameters.

8. The method of claim 1, further comprising determining a length of stay, for a user, at a service location of a merchant matching the first merchant category, the length of stay being determined based on real-time navigation and location data retrieved from one or more navigation-related applications running on a mobile device of the user.

9. The method of claim 8, further comprising increasing the second transaction amount in proportion to the length of stay at the service location of the merchant.

10. A system for electronic processing of two-step transactions, the system comprising:
a computer hardware arrangement configure to:
identify, based on transaction string data, a transaction message encoding a merchant identifier associated with a first merchant category, the transaction message corresponding to a request for a first transaction amount;
process the first transaction amount with one or more logical operations to compute a second transaction amount, wherein the one or more logical operations are derived from one or more user-specified tipping parameters associated with the merchant identifier; and
transmit, in response to the transaction message for the first transaction amount, a transaction validation message for the second transaction amount, to a payment gateway associated with the transaction request for the first transaction amount.

11. The system of claim 10, wherein the computer hardware arrangement is configured to compute the second transaction amount by calculating a gratuity amount based on, the merchant identifier, the first transaction amount and the one or more user-specified tipping parameters associated with the merchant identifier, and increase the first transaction amount by the gratuity amount calculated.

12. The system of claim 10, wherein the one or more logical operations are selected from a set of logical operations associated a user payment account.

13. The system of claim 12, wherein the computer hardware arrangement is configured to access the set of logical operations to compute the second transaction amount, via one or more Application Programming Interface (API) calls.

14. The system of claim 10, further comprising a modified user interface to retrieve one or more user-specified tipping parameters, the modified user interface being implemented as one or more of a payment application interface stored on a user mobile device and a web interface associated with a user payment account.

15. The system of claim 14, wherein the computer hardware arrangement is further configured to transmit a notification message, via the modified user interface, to prompt for a user confirmation of the second transaction amount.

16. The system of claim 10, wherein the first merchant category correspond to a user-provided listing of merchant identifiers associated with one or more user-specified tipping parameters.

17. The system of claim 10, wherein the computer hardware arrangement is further configured to determine a length of stay, for a user, at a service location of a merchant matching the first merchant category, the length of stay being determined based on real-time navigation and location data retrieved from one or more navigation-related applications running on a mobile device of the user.

18. The system of claim 17, wherein the computer hardware arrangement is further configured to scale the second transaction amount based on the length of stay at the service location of the merchant.

19. A non-transitory computer-accessible medium comprising instructions for execution by a computer hardware arrangement, wherein, upon execution of the instructions the computer hardware arrange is configured to perform procedures comprising:
identifying, based on transaction string data, a transaction message encoding a merchant identifier associated with a first merchant category, the transaction message corresponding to a request for a first transaction amount;
processing, by a transaction processing server, the first transaction amount with one or more logical operations to compute a second transaction amount, wherein the one or more logical operations are derived from one or more user-specified tipping parameters associated with the merchant identifier; and
transmitting, in response to the transaction request message for the first transaction amount, a transaction validation message for the second amount, to a payment gateway associated with the transaction request for the first transaction amount.

20. The non-transitory computer-accessible medium of claim 19, wherein a computation of the second transaction amount comprises: calculating a gratuity amount based on, the merchant identifier, the first transaction amount and the one or more user-specified tipping parameters associated with the merchant identifier, and increasing the first transaction amount by the gratuity amount calculated.
